(19) United States
(12) Patent Application Publication
(10) Pub. No.: US 2007/0071047 A1
(43) Pub. Date: Mar. 29, 2007

(54) 6K pulse repetition rate and above gas discharge laser system solid state pulse power system improvements

(75) Inventors: Chaofeng Huang, San Marcos, CA (US); Paul C. Melcher, El Cajon, CA (US); Richard M. Ness, San Diego, CA (US)

Correspondence Address: William C. Cray;Cymer, Inc., Legal Dept., 17075 Thornmint Court, MS/4-2C, San Diego, CA, 92127-2413, US

(73) Assignee: Cymer, Inc., San Diego, CA (US)

(21) Appl. No.: 11/300,979

(22) Filed: Dec. 15, 2005

Related U.S. Application Data
(63) Continuation-in-part of application No. 11/241,850, filed on Sep. 29, 2005.
(60) Provisional application No. 60/733,052, filed on Nov. 2, 2005.

(51) Int. Cl. H01S 3/04; H01S 3/00; H01S 3/22; H01S 3/223

(52) U.S. Cl. 372/38.02; 372/55; 372/34

(57) ABSTRACT

A method and apparatus for operating a very high repetition gas discharge laser system magnetic switch pulsed power system is disclosed, which may comprise a solid state switch, a charging power supply electrically connected to one side of the solid state switch; a charging inductor electrically connected to the other side of the solid state switch; a deque circuit electrically in parallel with the solid state switch comprising a deque switch; a peaking capacitor electrically connected to the charging inductor, a peaking capacitor charging control system operative to charge the peaking capacitor by opening the deque switch and leaving the solid state switch open and then shutting the solid state switch. The solid state switch may comprise a plurality of solid state switches electrically in parallel.

### CROSS-REFERENCE TO RELATED APPLICATIONS

The present application is a continuation-in-part of U.S. patent application Ser. No. 11/241,850, entitled GAS DISCHARGE LASER SYSTEM ELECTRODES AND POWER SUPPLY FOR DELIVERING ELECTRICAL ENERGY TO SAME, filed on Sep. 29, 2005, Attorney Docket No. 2005-0051-01, and claims priority to U.S. Patent Application No. 60/733,052, filed on Nov. 2, 2005, the disclosures of which is hereby incorporated by reference. The present application is related to U.S. Pat. No. 6,690,706, entitled HIGH REP-RATE LASER WITH IMPROVED ELECTRODES, issued to Morton et al. on Feb. 10, 2004, and U.S. Pat. No. 6,882,674, entitled 4 KHZ GAS DISCHARGE LASER SYSTEM, issued to Wittak et al on Apr. 19, 2005; and U.S. Pat. No. 6,442,181, entitled EXTREME REPETITION RATE GAS DISCHARGE LASER, issued to Oliver, et al. on Aug. 27, 2002; and U.S. Pat. No. 5,448,580, entitled AIR AND WATER COOLED MODULATOR, issued to Birx, et al. on Sep. 5, 1995, and U.S. Pat. No. 5,315,611, entitled HIGH AVERAGE POWER MAGNETIC MODULATORS FOR METAL VAPOR LASERS, issued to Ball et al. on May 24, 1994, and U.S. patent application Ser. No. 10/607,407, entitled METHOD AND APPARATUS FOR COOLING MAGNETIC CIRCUIT ELEMENTS, filed on Jun. 25, 2003, published on Dec. 30, 2004, Attorney Docket No. 2003-0051-01; the disclosures of each of which are hereby incorporated by reference.

### FIELD OF THE INVENTION

The present invention related to gas discharge laser systems operating at very high repetition rates of about 6 kHz and above and requiring certain modifications to solid state pulse power systems for supplying power to the electrodes for creating the gas discharges at very high current/voltage and very high pulse repetition rates.

### BACKGROUND OF THE INVENTION

As shown schematically in FIG. 1 a magnetic switch pulsed power circuit, basically known in the art (with the exception of certain component parameters and operating parameters modified from the known circuitry for operation at 6 kHz and above pulse repetition rates), e.g., for use in supplying high pulse repetition rate (4 kHz and above) electrical pulses between electrodes in a gas discharge laser system, e.g., a KrF or ArF excimer laser or other excimer lasers, e.g., XeCl, or XeF, or other gas discharge lasers, e.g., CO₂ laser systems).

Such a pulsed power circuit may include, as illustrated in FIG. 1, e.g., a high voltage power supply 20, a commutator module 50, a compression head module 60 and a laser chamber module 80. The high voltage power supply module 20 can comprise, e.g., for a 4 kHz pulse repetition rate laser, a 600 volt rectifier 22 for, e.g., converting the 480 volt three phase normal plant power from an electrical power AC source 10 to about 600 volt DC. An inverter 24, e.g., converts the output of the rectifier 22 to, e.g., high frequency 600 volt pulses in the range of 10 kHz to 100 kHz. The frequency and the on period of the inverter 24 can be controlled, e.g., by a HV power supply control board (not shown) in order to provide course regulation of the ultimate output pulse energy of the power supply system 20, e.g., based upon the output of a voltage monitor comprising, e.g., a voltage divider 44, e.g., in the commutator module 20.

The output of the inverter 24 can be stepped up to about 800 volts in a step-up transformer 26. The output of transformer 26 can be converted to 800 volts DC by a rectifier 28, which can include, e.g., a standard bridge rectifier circuit and a filter capacitor 34. The power supply module 20 can be used to take the DC output of a source 10, e.g., to charge, e.g., an 5.1 μF charging capacitor C₀ in the commutator module 50 as directed by a control board (not shown), which can, e.g., control the operation of the power supply module 20 to set this voltage. Set points, e.g., within the HV source 10 or power supply control board(s) (not shown) can be provided by a laser system control board (not shown). In the discussed embodiment, e.g., pulse energy control for the laser system can be provided by regulating the voltage supplied by the set of the power source 10 to the power supply module 20 and the power supply module 20 to C₀ 42 in the commutator module 50.

The electrical circuits in commutator module 50 and compression head module 60 may, e.g., serve to amplify the voltage and compress the pulses of electrical energy stored on charging capacitor C₀ 42 by the power supply 18, including the source 10 and power supply module 20 module 20, e.g., to provide 800-1200 volts to charging capacitor C₀, which during the charging cycle can be isolated from the down stream circuits, e.g., by a solid state switch 46, which actually may comprise a plurality, e.g., two or three, solid state switches in parallel, e.g., in order to reduce the current flow through each.

The commutator module 40, which can comprise, e.g., the charging capacitor C₀, which can be, e.g., a bank of capacitors connected in parallel to provide a total capacitance of, e.g., 5.1 μ.F, along with the voltage divider 44, in order to, e.g., provide a feedback voltage signal to the HV power source 10 or power supply module 20 control board (not shown) which can be used by control board to limit the charging of charging capacitor C₀ 42 to a voltage (so-called “control voltage”), which, e.g., when formed into an electrical pulse and compressed and amplified in the commutator 40 and compression head 50, can, e.g., produce the desired discharge voltage on a peaking capacitor Cₚ 82 and across electrodes 83,84 in the lasing cavity chamber 80.

As is known in the art, e.g., for a laser system operating at around 4 kHz, and also for a laser system operating at around 6 kHz or above, such a circuit 50, 60, 80 may be utilized to provide pulses in the range of 3 or more Joules and greater than 14,000 volts at pulse rates of 4,000 or more pulses per second. In such a circuit, e.g., at 4 kHz and above, about 160 microseconds may be required for DC power source 10 and power supply module 20 to charge the charging capacitor C₀ 42 to, e.g., between about 800-1200 volts. At 6 kHz and above the charging time is reduced to about 100 microseconds, and so forth as pulse repetition rate increases.

Charging capacitor C₀₋₄₂, therefore, can, e.g., be fully charged and stable at the desired voltage provided the voltage and current applied to the charging capacitor C₀ 42 in the amount of time allowed by the pulse repetition rate can be accomplished. For example, when a signal from a commutator control board (not shown) is provided, e.g., to close the solid state switch 46, which, e.g., initiates a very fast step of converting the 3 Joules of electrical energy stored on charging capacitor C₀ 42 into, e.g., a 14,000 volt or more charge on peaking capacitor Cₚ 82 for creating a discharge across the electrodes, 83, 84, provided the charging capacitor C₀ has been adequately charged within the time allotted by the pulse repetition rate of the laser system.

The solid state switch 46 may be, e.g., an IGBT switch, or other suitable fast operating high power solid state switch, e.g., an SCR, GTO, MCT, high power MOSFET, etc. A 600 nH charging inductor L₀ 48 can be placed in series with the solid state switch 46 and employed, e.g., to temporarily limit the current through the solid state switch 46 while it closes to discharge the charge stored on charging capacitor C₀ 42 onto a first stage capacitor C₁ 52 in the commutator module, 50 e.g., forming a first stage of pulse compression in the commutator module 50.

For the first stage of pulse generation and compression, the charge on charging capacitor C₀ can be switched onto a capacitor, e.g., a 5.7 μF capacitor C₁, e.g., in about 4 μs. A saturable inductor L₁ 54 can hold off the voltage on capacitor C₁ 52 until the saturable reactor L₁ 54 saturates, and then present essentially zero impedance to the current flow from capacitor C₁ 52, e.g., allowing the transfer of charge from capacitor C₁ 52 through, e.g., a step up transformer 56, e.g., a 1:25 step up pulse transformer, in order to charge a capacitor Cₚ₋₁ 62 in the compression head module 60, with, e.g., a transfer time period of about 400 ns, comprising a second stage of compression.

The design of pulse transformer 56 is described in a number of prior patents assigned to the common assignee of this application, including, e.g., U.S. Pat. No. 5,936,988. For example, such a transformer 56 is an extremely efficient pulse transformer, transforming, e.g., a 800 volt 5000 ampere, 400 ns pulse to, e.g., a 20,000 volt, 200 ampere 400 ns pulse, which, e.g., is stored very temporarily on compression head module capacitor Cₚ₋₁ 62, which may also be, e.g., a bank of capacitors. The compression head module 60 may, e.g., further compress the pulse. A saturable reactor inductor Lₚ₋₁ 64, which may be, e.g., about a 125 nH saturated inductance, can, e.g., hold off the voltage on capacitor Cₚ₋₁ 62 for approximately 400 ns, in order to, e.g., allow the charge on Cₚ₋₁ 62 to flow, e.g., in about 100 ns, onto a peaking capacitor Cₚ 82, which may be, e.g., a 10.0 nF capacitor located, e.g., on the top of a laser chamber and which peaking capacitor Cₚ 82 is electrically connected in parallel with the laser system electrodes 83, 84.

This transformation of a, e.g., 400 ns long pulse into a, e.g., 100 ns long pulse to charge peaking capacitor Cₚ 82 can make up, e.g., the second and last stage of compression. About 100 ns after the charge begins flowing onto peaking capacitor Cₚ 82 (which may be a bank of capacitors in parallel) mounted on top of and as a part of the laser chamber in the laser chamber module, the voltage on peaking capacitor Cₚ 82 will have reached, e.g., about 20,000 volts and a discharge between the electrodes begins. The discharge may last, e.g., about 50 ns, during which time, e.g., lasing occurs within the resonance chamber of the, e.g., excimer laser.

According to aspects of an embodiment of the present invention may comprise operation of laser systems requiring, e.g., precisely controlled electrical potentials in the range of about 12,000 V to 20,000 V be applied between the electrodes at around 6,000 Hz and above (i.e., at intervals of about 166 micro seconds). As indicated above in known magnetic switch pulse power systems the charging capacitor bank C₀ 42 can be is charged to a precisely predetermined control voltage and the discharge can be produced by closing the solid state switch 46 which can then allow the energy stored on the charging capacitor C₀ 42 to ring through the magnetic compression-amplification circuitry 50, 60 and 80 to produce the desired potential across the electrodes 83, 84. The time between the closing of the switch 46 to the completion of the discharge is only a few microseconds, (i.e., about 5 microseconds) but the charging of C₀ 42 can require a time interval much longer than 166 microseconds. It is known, however, to reduce the charging time, e.g., by using a larger power supply. Alternatively, using power supplies in parallel can reduce the charging time. For example, it has bee shown that one is able to operate at around 4,000 Hz, e.g., by using three prior art power supplies such as those shown illustratively as element 18 in FIG. 1, arranged in parallel.

In such an embodiment, one may also utilize the same basic design as in the prior art shown in FIG. 1 for the portion of the pulse power system downstream of the solid state switch 46. One may also implement a known different technique for charging C₀₋₄₂, e.g., as illustrated schematically and in block diagram form in FIGS. 2 and 3. Applicants' assignee Cymer, Inc. refers to such techniques as resonant charging, of which at least two alternative apparatus and methods may be employed as illustrated by way of example in FIGS. 2 and 3, respectively, which are taken from the above referenced U.S. Pat. No. 6,442,181, resulting in, e.g., very fast charging of C_{0-42.}

A standard dc power supply 200 having a 208 VAC/90 amp input and an 800 VDC 50 amp output may be used. The power supply 200 may be a dc power supply adjustable from approximately 600 volts to 800 volts. The power supply 200 may be attached directly to a storage capacitor C-1 202, in a resonant charger 220, which may be, e.g., a 1033 μF capacitor. When the power supply 200 is enabled it turns on and regulates a constant voltage on the C-1 capacitor 202. The performance of the system is somewhat independent of the voltage regulation on C-1 202. The power supply 200 may be, e.g., a constant current, fixed output voltage power supply such as is available from Elgar, Universal Voltronics, Kaiser and EMI.

The power supply 200 may continuously charges the 1033 μ.F capacitor 202 to the voltage level commanded by the control board 204, in the embodiment of FIG. 2. The control board 204 may also command IGBT switch 206 (which may be a plurality of switches in parallel) closed and open to transfer energy from capacitor 202 to capacitor C₀ 42. A charging inductor 208 in the resonant charger 220 may sets up the transfer time constant in conjunction with capacitor 202 and 42 and limits the peak charging current. Control board 204 receives a voltage feedback 212 (e.g., as shown in FIGS. 2 and 3) that is proportional to the voltage on capacitor 42 and a current feedback 214 (e.g., as shown in FIG. 3 that is proportional to the current flowing through inductor 208. From these two feedback signals control board 204 can calculate in real time, e.g., a final voltage on capacitor 42 should IGBT switch 206 open at that instant of time. Therefore with a command voltage 210 fed into control board 204 a precise calculation can be made of the stored energy within capacitor 42 and inductor 208 to compare to the required charge voltage commanded 210. From this calculation, the control board 204 can, e.g., also determine the exact time in the charge cycle to open IGBT switch 206.

After IGBT switch 206 opens the energy stored in the magnetic field of inductor 208 can transfer to capacitor 42 through a free-wheeling diode (215 in FIG. 2 or 217 in FIG. 3). The accuracy of the real time energy calculation can determine, e.g., the amount of fluctuation dither that will exist on the final voltage on capacitor 42. Due to the extreme charge rate of this system, too much dither may exist to meet a desired systems regulation need of ±0.05%. Therefore the circuit may also include, for example, a de-qing circuit or a bleed-down circuit as discussed below.

A second resonant charger system is shown illustratively and in block diagram form by way of example in FIG. 3. This circuit is similar to the one shown in FIG. 2. Principal circuit elements may include the three-phase power supply 200 with a constant DC current output, the source capacitor C-1 202 that is an order of magnitude or more larger than the existing C₀ capacitor 42 (e.g., a 1033 μF capacitor. Switches Q1, 206, Q2 218, and Q3 216 can be used to control current flow for charging and maintaining a regulated voltage on charging capacitor C₀₋₄₂. Diodes D1 215, D2 217, and D3 219, which may be a bank of diodes in parallel, can provide for the direction of current flow. Resisters R1 230, and R2 232 provide a voltage divider circuit for voltage feedback 212 to the control circuitry on the control board 204. Resistor R3 240, shown in FIG. 2 to be a 0.001 ohm resistor and in FIG. 3 to be a 500 ohm resistor can be used to allows for rapid discharge of the voltage on the charging capacitor C₀ 42 to bleed down the charge on the capacitor 42 in the event of an over charge on the capacitor 42, as detected, e.g., by the voltage divider circuit of resisters 230, 232. A resonant inductor L1, 242 between capacitors C-1 202 and C₀ 42 may serve to limit current flow and setup charge transfer timing. The control board 204 may provide commands to the switches Q1 206, Q2 218, and Q3 216 to, e.g., open and close the switches based upon, e.g., circuit feedback parameters. The difference in the circuit of FIG. 2 from that of FIG. 3 is, e.g., the addition of switch Q2 218 and diode D3 219, which can provide a de-Qing function. This switch 218 can be used to improve the regulation of the circuit by allowing the control unit 204 to short out the inductor L1 208 during the resonant charging process. This “de-Qing” can be used, e.g., to prevent additional energy stored in the charging inductor, L1 208, from being transferred to capacitor C₀.

Prior to the need for a laser pulse the voltage on capacitor C-1 202 can be charged to, e.g., 600-800 volts and switches Q1 206, Q2 218 and Q3 216 may be open. Upon a command from the laser system controller (not shown), the control board 204 can provide a command 206′ to switch Q1 206 to close the switch Q1 206. At this time current would flow from capacitor C-1 202 to charging capacitor Co 42 through the charging inductor L1 208, since switch Q2 can be open at this time. A calculator 205 on the control board 204 could be used to evaluate the voltage on C₀ 42 and the current flowing in inductor L1 208, from feedback signals 212, 214, relative to a command voltage set point from the laser. Switch Q1 206 can then be opened by a command 206′ from the control board 204 when the voltage on charging capacitor C₀ 42 plus the equivalent energy stored in inductor L1 206 equals the desired command voltage. The calculation is:
V_{f}=[V_{C0s}²+((L₁*I_{L1s}²)/C₀)]^{0.5}

where: V_{f}=a final voltage on C₀ after switch Q1 206 opens and the current in inductor L1 208 goes to zero; V_{C0s} is the starting voltage on C₀ when switch Q1 206 opens; I_{L1s} is the current flowing through L₁ when switch Q1 206 opens. After switch Q1 206 opens the energy stored in inductor L1 208 continues transferring to C₀ through diode D2 217 until the voltage on C₀ approximately equals the command voltage. At this time switch Q2 218 can be closed and current stops flowing to charging capacitor C₀ 42 and is directed through diode D3 219. In addition to the “deque” circuit, 218, 219, switch Q3 216 and resistor R3 240 form a bleed-down circuit to allow additional fine regulation of the voltage on C₀ to a target charging voltage.

Switch Q3 of bleed down circuit 216, 240 can be commanded to close, e.g., by the control board 204, e.g., when current flowing through inductor L1 208 stops and the voltage on charging capacitor C₀ can be bled down to the desired charging voltage. Then switch Q3 216 can be opened. The time constant of capacitor C₀ 42 and resistor R3 240 can be selected to be sufficiently fast to bleed down capacitor C₀ 42 to the commanded charging voltage without being an appreciable amount of the total charge cycle.

As a result, the resonant charger 220 can be configured with three levels of regulation control. Somewhat crude regulation may be provided by the energy calculator and the timing of the opening of switch Q1 206 during the charging cycle. As the voltage on C₀ nears the target charging voltage value, the deque switch Q2 218 may be closed, stopping the resonant charging when the voltage on C₀ is at or slightly above the target value. Finally, as a third control over the voltage regulation the bleed-down circuit of switch Q3 216 and R3 240 can be used to discharge C₀ down to the precise target value.

According to aspects of an embodiment of the present invention these known magnetic switch pulsed power supply systems may carry out parallel non-resonant charging, e.g., for operation of laser systems at pulse rates of 4,000 Hz to 6,000 Hz can be accomplished with the prior art charging system technology shown as element 20 in FIG. 1. However, to provide the needed charging speed, much greater charging capacity is required. For example, applicants' assignee's laser systems have successfully been operated at laser output pulse (and thus also gas discharge electrical pulse) repetition rates of 4,900 Hz using, e.g., three of the FIG. 1 power supplies in parallel. For operation at 6,000 Hz five (preferably six) of these power supplies could be needed.

According to aspects of an embodiment of the present invention the resonant chargers of FIGS. 2 and 3 may be employed but applicants have found that certain other modifications and improvements may be necessary for operation at 6 kHz and above. The present application addresses such issues. It will also be understood that commands mentioned above, e.g., to certain switches may be, e.g., in the form of an applied voltage or current to open or shut the respective switch. The solid state switch 46 may comprise an P/N CM 800 HA-34H IGBT switch provided by Powerex, Inc. with offices in Youngwood, Pa. In a preferred embodiment, as noted, at least two such switches may be used in parallel. Inductors, e.g., 54 and 64 may be saturable inductors similar to those used in prior systems as described in the above referenced U.S. Pat. Nos. 5,448,580 and 5,315,611. It is also discussed in Ness, et al., “A Decade of Solid State Pulsed Power Development at Cymer Inc.” Proceedings of the 26th IEEE International Power Modulator Symposium and High Voltage Workshop, San Francisco, (2004), pp 228-233.

A technique for water cooling a step-up transformer is disclosed in U.S. Pat. No. 5,448,580, entitled AIR AND WATER COOLED MODULATOR, issued to Birx, et al on Sep. 5, 1995 disclosing:
With reference again to FIG. 5, the system used in the present invention to cool transformer 22 is also shown. A cold plate 106 is attached to the primary winding assemblies 20 to carry heat therefrom. Cold plate 106 may be cooled, for example, by flowing cooling water through channels 108 in cold plate 106. In the present embodiment, cooling water is supplied to cold plate 106 using flexible tubing, not shown. (Col. 9, lines 19-26) The referenced FIG. 5 simply shows a single channel passing through a single piece cooling plate.

A jitter control circuit is discussed in Huang, et al., “Low Jitter And Drift High Voltage IGBT Gate Driver, Proceedings of the 14th IEEE Pulsed Power Conference, Dallas (2003), pp 127-130, Abstract No. 100055.

### SUMMARY OF THE INVENTION

A method and apparatus for operating a very high repetition gas discharge laser system magnetic switch pulsed power system is disclosed, which may comprise a solid state switch, a charging power supply electrically connected to one side of the solid state switch; a charging inductor electrically connected to the other side of the solid state switch; a deque circuit electrically in parallel with the solid state switch comprising a deque switch; a peaking capacitor electrically connected to the charging inductor, a peaking capacitor charging control system operative to charge the peaking capacitor by opening the deque switch and leaving the solid state switch open and then shutting the solid state switch. The solid state switch may comprise a plurality of solid state switches electrically in parallel. The peaking capacitor charging control system may be operative to charge the peaking capacitor by leaving the deque switch open until substantially all of the electrical energy stored in the charging inductor has been removed before shutting the solid state switch. The very high repetition gas discharge laser system magnetic switch pulsed power system may comprise a solid state switch; a charging power supply electrically connected to one side of the solid state switch; a charging inductor electrically connected to the other side of the solid state switch; a peaking capacitor electrically connected to the charging inductor, a delay circuit operative to charge the peaking capacitor with electrical energy stored in the charging inductor prior to shutting the solid state switch. The very high repetition gas discharge laser system magnetic switch pulsed power system may comprise a step-up transformer comprising a plurality of winding pucks each comprising a turn primary winding around a secondary winding; each of the plurality of pucks contained in at least two separate sections of primary winding pucks laid out on a step-up transfer mounting board at angles to each other generally forming an L or a U or an O shaped compilation having a first and a second end; a cooling plate having a plurality of sections each respectively in thermal contact with a respective one of the at least two separate sections of the primary winding pucks; the cooling plate may comprise a plurality of cooling channels arranged in at least one grouping of a pair of channels extending in a flow direction from the first end to the second end and returning to the first end, from a cooling fluid inlet at the first end to a cooling fluid outlet at the first end. The cooling channels may comprise a channel internal to the cooling plate. The cooling channel may be formed in at least a first half of the cooling plate and the first half of the cooling plate is joined to a second half of the cooling plate. The cooling channel may comprise a cooling fluid duct contained in a cooling fluid duct passage groove formed in a surface of the cooling plate. The cooling fluid duct may comprise thermally conductive tubing. The very high repetition gas discharge laser system magnetic switch pulsed power system may comprise a step-up transformer comprising a plurality of winding pucks each comprising a turn primary winding around a secondary winding; a void space between an internal surface of each respective primary winding puck and an insulation sleeve on the secondary winding; and insulation fluid in the void space. The insulation fluid may comprise a dielectric gas, e.g., a noble gas, e.g., N₂, or a dielectric liquid, e.g., a dielectric oil. The very high repetition gas discharge laser system magnetic switch pulsed power system may comprise a solid state switch anti-jitter and anti-drift circuit which may comprise an optoisolator circuit spanning the boundary between the high voltage side of the circuit and the low voltage side of the circuit, which may comprise an opto-transmitter on the low voltage side of the circuit and an opto-receiver on the high voltage side of the circuit. The circuit may comprise a comparator in series with the opto-receiver and the solid state switch between the opto-receiver and the solid state switch. The opto-transmitter may be connected to a trigger input signal and the comparator may be connected to an MOSFET driver circuit.

### BRIEF DESCRIPTION OF THE DRAWINGS

FIG. 1 shows schematically and partly in block diagram form a magnetic switch pulsed power supply system useful according to aspects of an embodiment of the present invention;

FIG. 2 shows schematically and partly in block diagram form a resonant charging circuit useful according to aspects of an embodiment of the present invention;

FIG. 3 shows schematically and partly in block diagram form a resonant charging circuit useful according to aspects of an embodiment of the present invention;

FIG. 4 shows illustratively by way of example in schematic and partly in block diagram form a delay circuit according to aspects of an embodiment of the present invention;

FIG. 5A shows schematically and partly in block diagram form a known solid state pulse power supply system solid state switch anti-jitter and drift control circuit;

FIG. 5B shows schematically and partly in block diagram format a solid state pulse power supply system solid state switch anti-jitter and drift control circuit according to aspects of an embodiment of the present invention;

FIG. 6 shows a plan view of a portion of a cooling plate for a solid state pulse power supply system step-up transformer according to aspects of an embodiment of the present invention;

FIG. 7 shows a perspective view of a cooling plate for a solid state pulse power supply system step-up transformer according to aspects of another embodiment of the present invention;

FIG. 8 shows a side view of the embodiment of FIG. 7;

FIG. 9 shows a plan view of a solid state pulse power supply system step-up transformer according to aspects of an embodiment of the present invention;

FIG. 10 shows a cross sectional side view of a section of a solid state pulse power supply system step-up transformer according to aspects of another embodiment of the present invention, along lines 10-10 of FIG. 9;

FIG. 11 shows an enlarged view of a portion of the embodiment of FIG. 10;

FIG. 12 Shows an orthogonal perspective view of a portion of the embodiment of FIG. 9;

FIG. 13 shown an orthogonal perspective view of a primary winding puck of a solid state pulse power supply system step-up transformer according to aspects of an embodiment of the present invention;

FIG. 14 shows a perspective view of an end flange for a section of a solid state pulse power supply system step-up transformer according to aspects of an embodiment of the present invention;

FIG. 15 shows an orthogonal partially cut away view of the end flange of FIG. 14;

FIG. 16 shows a perspective orthogonal view of a puck isolator according to aspects of an embodiment of the present invention;

FIG. 17 shows schematically in more detail portions of the prior art pulse power circuit of FIG. 1; and,

FIG. 18 shows schematically modifications to the circuit of FIG. 17 according to aspects of an embodiment of the present invention.

### DETAILED DESCRIPTION OF PREFERRED EMBODIMENTS

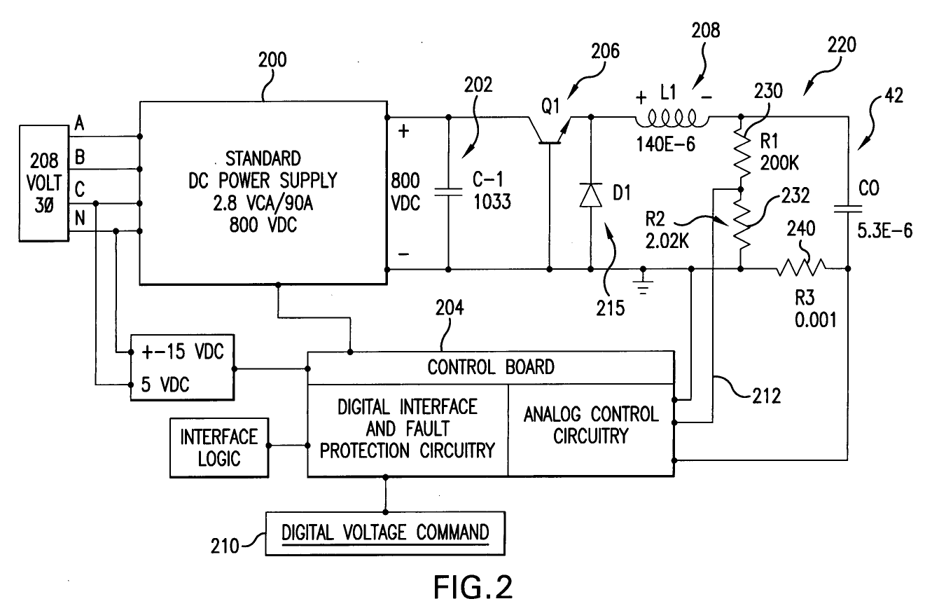

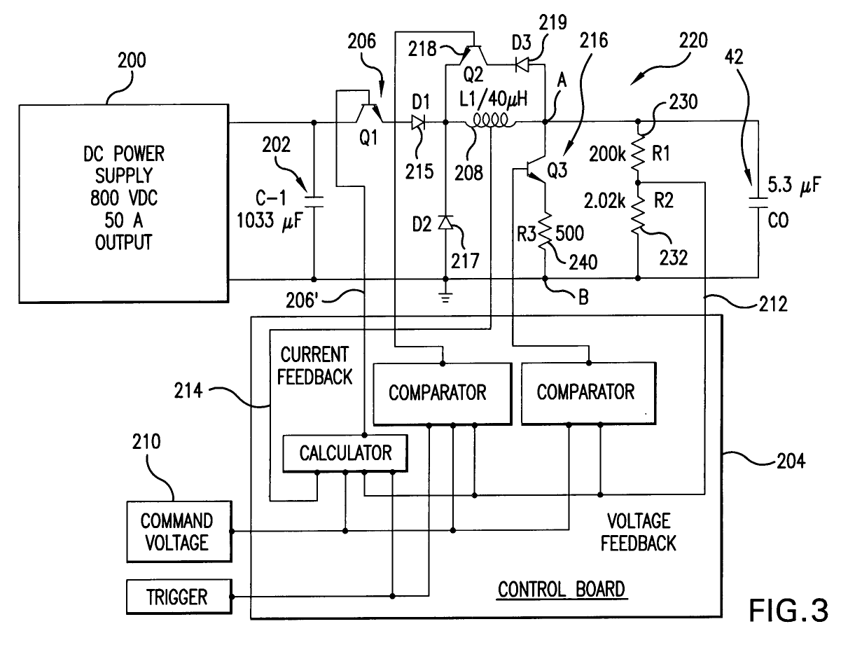

According to aspects of an embodiment of the present invention an issue to address is that the peak current in the charging inductor of a resonant charger (“RC”) module, e.g., 220 shown illustratively in FIGS. 2 and 3 can increase with the 2nd (and on) pulses in a burst of laser system pulsed output light beam pulses since current (stored or recovered energy) may already exist in the charging inductor, e.g., inductor L1 208 shown, e.g., in FIGS. 2 and 3, remaining from the energy recovery cycle of the previous pulse. When the charging switch, e.g., switch Q1 206 shown illustratively in FIGS. 2 and 3, is closed, current also flows from the C-1 capacitor 202, also illustratively shown in FIGS. 2 and 3. This current adds to the already existing energy recovery current and can cause the peak current in the switch Q1 206 to go higher than it would be for the first pulse. This increases the requirements (for current) of the charging switch Q1 206 (and additional components e.g., D1 215 and L1 208) and can also lead to higher losses in the charging switch Q1 206 (and other components e.g., D1 215 and L1 208).

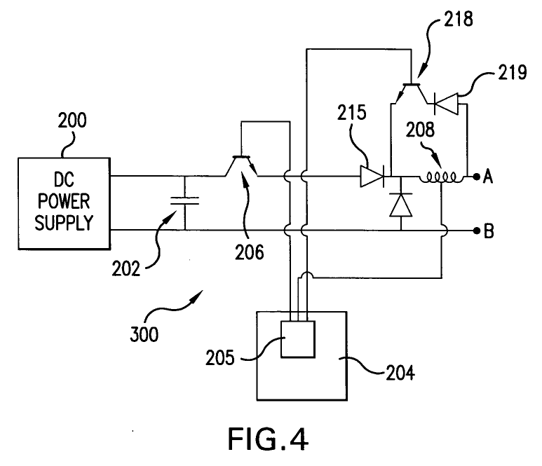

In order to deal with this, applicants have proposed the implementation a circuit, shown schematically and partly in block diagram form in FIG. 4, which can lessen the current flow through the switch Q1 206 and the other components, e.g., by delaying the closure of the charging switch Q1 206 until the energy recovery current already stored in the charging inductor L1 208 has had a chance to decay and thereby charge the charging capacitor C₀ 42 in the commutator of the pulsed power supply system. The circuit 300 shown illustratively by way of example in FIG. 4 may, e.g., employ a charging control calculator 205 on the charging control board 204, e.g., to simply delay the charging switch 206 closure until the current passing through the charging inductor 208 drops below a preset value.

In this manner, the operation of the known resonant charger circuit, e.g., as shown in FIG. 3 is modified, e.g., such that switch 218 in the de-quing circuit 218, 219 is opened once the resonant charger circuit is commanded to begin charging, allowing current flowing through the charging inductor L1 208 to flow into the charging capacitor C₀ 42, until substantially all of the current is used to charge the charging capacitor C₀₋₄₂, i.e., current flow in the charging inductor L1 208 is zero or substantially zero. Once the current from the prior pulse has been dissipated, the charging switch 206 is commanded closed by the charging control calculator 205 to allow additional charging of the C0 capacitor 42 from the C-1 capacitor 202. The normal charging sequence is then followed where the charging switch 206 is opened by the energy calculator circuit and then the deque switch 218 and bleed switch 216 are closed to achieve precise regulation of the charging voltage. In this way, the total current seen by the charging switch and other components may be limited to less that what it would be with the dissipation of the current in the charging inductor L1 208 and the charge on capacitor C-1 202 through the switch 206 and other components.

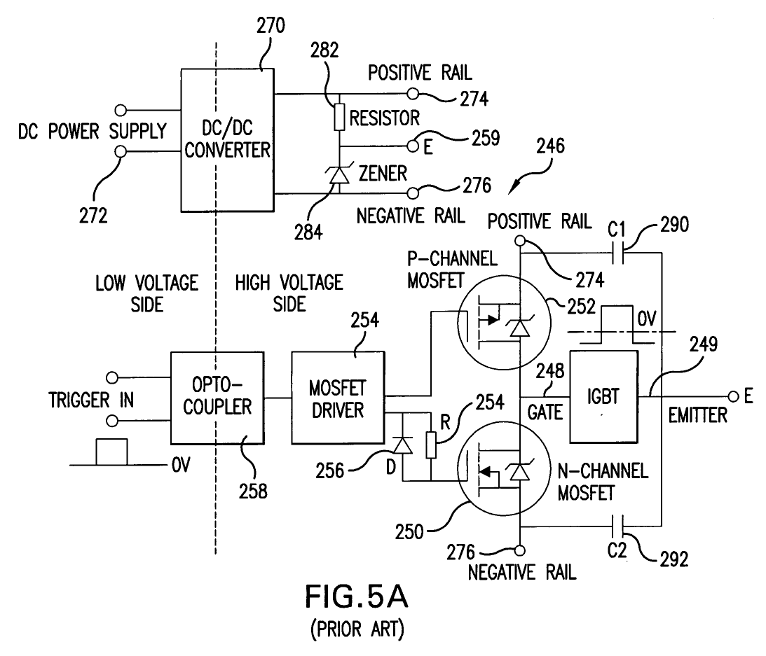

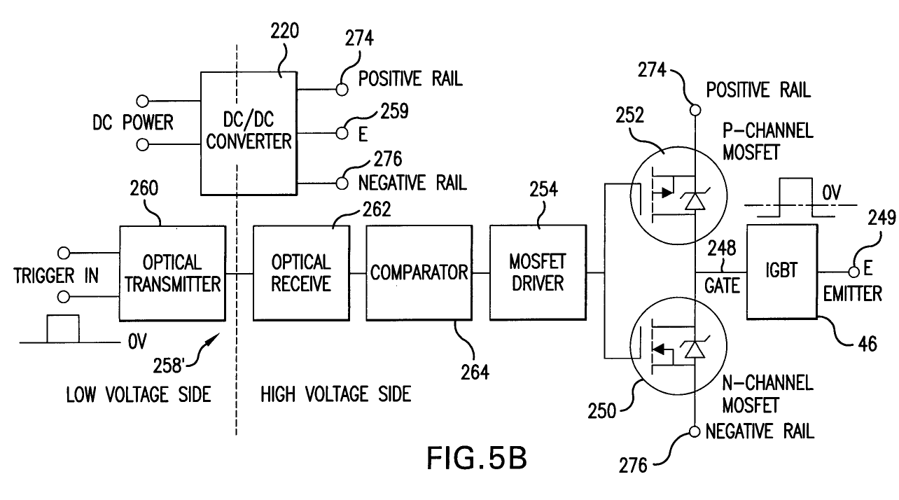

Turning now to FIG. 5A there is shown by way of illustration a of a prior art solid state pulse power system solid state switch drift and jitter control circuit 246 that is currently on the market in laser systems sold by applicant's assignee, such as XLA 100 multichamber laser systems. The jitter control circuit 246 as discussed in the above noted reference, may comprise, e.g., an IGBT solid state switch, e.g., 46, e.g., one as noted above, (which may be one of a plurality of such IGBTs in parallel) having an IGBT gate 248 and an IGBT emitter 249 and a pair of fast switching MOSFETs. An N-channel MOSFET 250 and a P-channel MOSFET 252. The circuit may also include a MOSFET driver 254, which may be connected to the gate of N-Channel MOSFET by a resistor 254 and a diode 256 and to the gate of the P-channel MOSFET 252.

The circuit 246 may also comprise an optocoupler 258 connected across the low voltage to high voltage transition of the circuit 246, the high voltage side being connected to a DC/DC converter 270, a model THI-2421, made by TRACO ELECTRONIC AG, Switzerland, which can, e.g., convert a DC voltage supplied by a DC power supply 272 to the DC voltage connected, e.g., to the collector of the IGBT 46, providing a positive rail 274 to negative rail 276 voltage on the emitter 249 of the IGBT 46 when the IGBT switch 46 is shut.

The circuit 246 may also comprise a resistor 282, which may be a 1670 ohm resistor, connected between the positive rail 274 and common ground 249 and two zener diodes 284 in parallel, e.g., a model 1N4734A, made by ON Semiconductor, U.S.A. connected between the negative rail 276 and common ground 249. The circuit 246 may also comprise a capacitor, e.g., a 100 μF 290 connected to the positive rail 274 and the IGBT emitter 249 and a capacitor, e.g., a 100° F. capacitor.

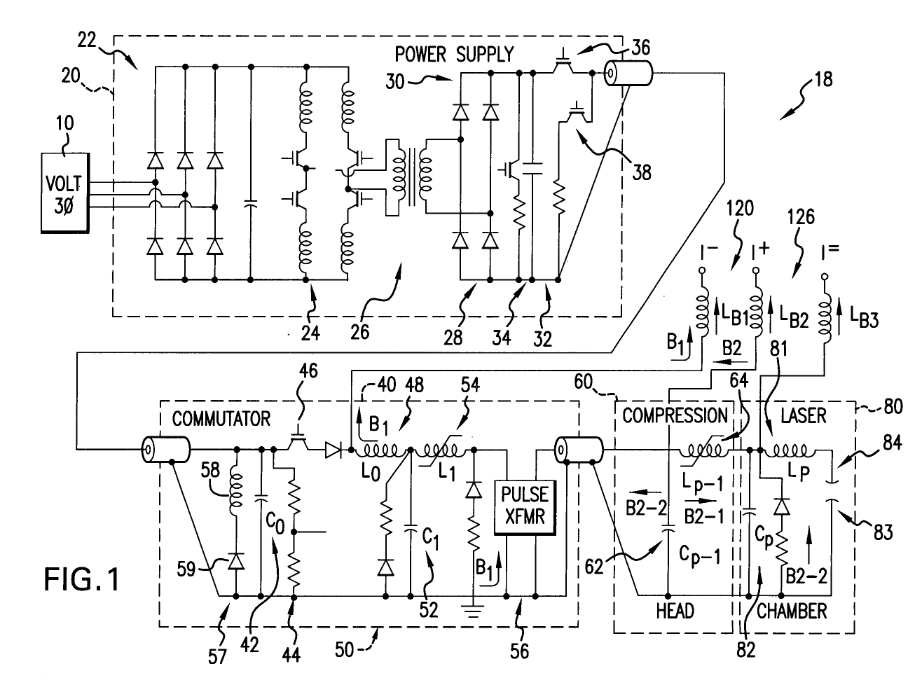

Such a circuit 246, e.g., with a high speed optocoupler 258, e.g., a model HCPL-2611#020 which can be obtained from AGILENT TECHNOLOGIES, U.S. A., an ultrafast MOSFET driver 254, e.g., a model 1×DD404PI, which can be obtained from IXYS CORPORATION, U.S.A. and the fast switching MOSFETs, e.g., model IRFU5305, and IRFU4105, which can be obtained from INTERNATIONAL RECTIFIER, U.S.A., can be utilized to insure, e.g., minimum jitter, turn on delay, turn on time, turn off time, turn-off delay, turn on/off drift and power loss from the receipt of a trigger input signal 259 to the shutting of the IGBT 46 and the application of the voltage on charging capacitor C₀ 42 onto capacitor C₁ 52 through inductor L₀ 48, as illustrated in the circuit of FIG. 1.

In operation, e.g., the circuit 246 provides a fully isolated gate driver operable up to relatively high Cₚₖ discharge pulse rates, e.g., around 4000 pulses per second, using the high isolation voltage optocoupler 258, and optoisolator, and the DC/DC converter 270 to isolate the trigger signal 259 from the high voltage side of the circuit 246. The resistor 282 and zener diode 284 can provide voltage regulation to generate the positive rail 274 and reference ground 259. The outputs of the N-channel MOSFET 250 and P-channel MOSFET 252 may be connected common drain for rail to rail output to the IGBT gate 248 and emitter 249, e.g., to ensure reliable operation. The IGBT 46 gate driver 254 may be mounted, close to, e.g., directly on top of the IGBT 46 to minimize inductances. The resistor 254, which may be, e.g., a 100 ohm resistor, in parallel with a diode, e.g., a Schottky, e.g., a model IN5818, made by ON SEMICONDUCTOR, U.S.A. may serve, e.g., to reduce the power loss due to cross conduction of the two MOSFETs 250, 252, e.g., during turn of and turn on periods. When the trigger in signal 259 is low or no trigger in signal 259 exists, the output of the IGBT gate 248 and emitter 249 may be maintained at negative rail, e.g., in order to make sure that the IGBT 46 is off and will not turn on due to electrical noise in the circuit 246. Series gate resistors, e.g., between the MOSFETs 250, 252 outputs to the IGBT gate 248, though such gate resistors (not shown) could be employed. Capacitors 290, 292 may be used to store energy in charging and discharging the IGBT gate 248.

According to aspects of am embodiment of the present invention, as illustrated schematically and partly in block diagram form in FIG. 5B, an improved circuit 246′ may be essentially the same as the circuit 246 of FIG. 5A, with the exception that the optocoupler 258 may be replaced, e.g., with an improved optocoupler 258′ that may comprise an optical transmitter 260, e.g., on the low voltage side of the circuit 246′ and an optical receiver 262 on the high voltage side of the circuit 246′ along with a comparator 264. The optical transmitter 260 may be a model HFBR-1527, made by AGILENT TECHNOLOGIES, U.S.A. and the optical receiver 262 may be a model HFBR-2526, made by AGILENT TECHNOLOGIES U.S.A., and the comparator may be a model MAX961ESA, made by MAXIM, U.S.A.

Together the optical transmitter 260 and optical receiver 262, e.g., at higher operating pulse repetition rates, e.g., at about 6 kHz and above may be employed to provide a better voltage isolation between the high voltage side and the low voltage side, because the voltage isolation can be scaled by the length of the optical fiber cable between optical transmitter and optical receiver (as compared with the optocoupler 258 in FIG. 5A where the voltage isolation is limited by the device capabilities). The comparator 264 may serve to condition the signal from the optical receiver to make the signal amplitude large enough for the input of the MOSFET driver 254.

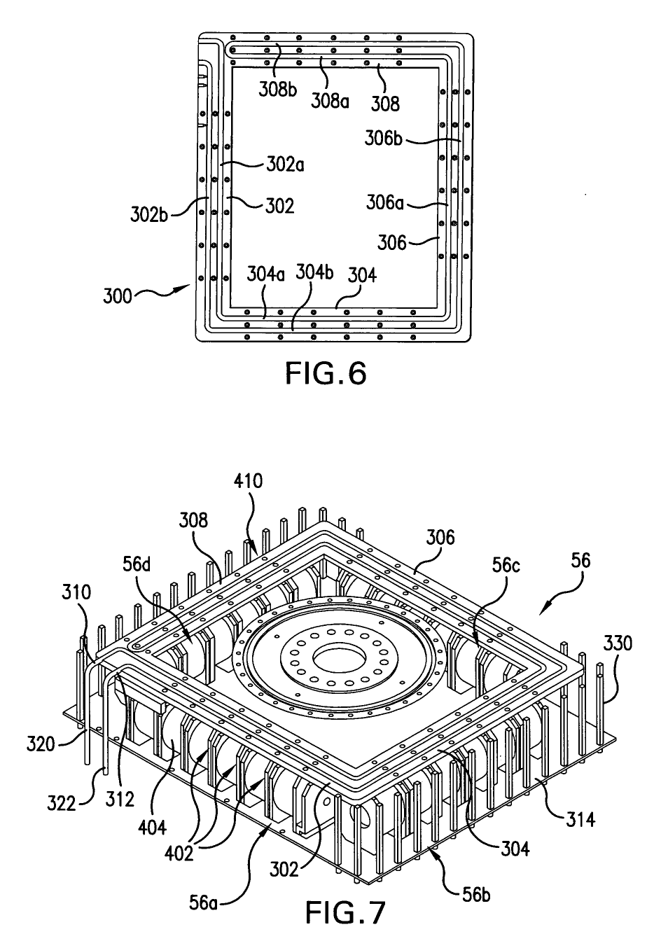

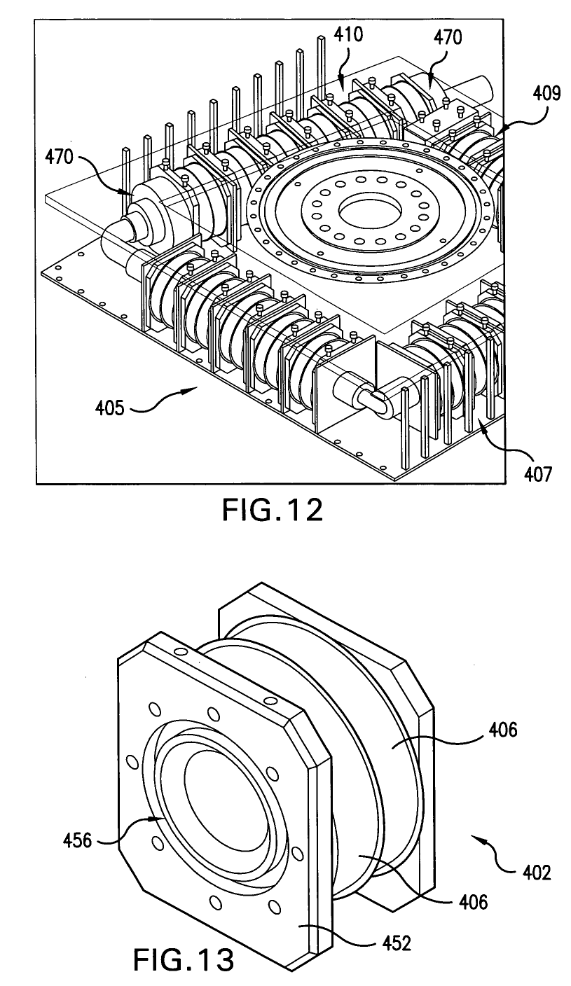

Turning now to FIGS. 6 and 7 there is shown, respectively a plan view of a cooling plate 300 for a step up transformer 56 according to aspects of an embodiment of the present invention. The cold plate 300 may have a plurality of sections 302, 304, 306 and 308, each corresponding to a section of the step up transformer, i.e., 56a, 56b, 56c, and 56d, corresponding generally to the sections 407, 408, 409 and 410, shown, e.g., in FIG. 12, except, e.g., for the number of pucks in each section and the angle of the high voltage final section 410, 56b with respect to the preceding section 56c, 409. These sections are shown by way of example to be laid out in a loop around a step up transformer mounting board 314, e.g., to maximize space utilization on the board 314 for the placement of the sections of the step up transformer 56 totaling a certain number of primary winding pucks. It will be understood that depending on, e.g., the number of primary winding pucks needed, the size of each, the space occupied by other circuit elements, etc. the step-up transformer may be laid out in generally an L shape, e.g., with sections 56a, and 56b shown in FIG. 7, or a generally L shaped configuration, e.g., with the sections just mentioned and also section 56c or in generally a loop or O-shaped configuration adding section 56d.

In operation, e.g., the first cooling channel 302a upstream of the cooling fluid inlet 210 would contain the coldest water circulating through the cooling fluid system and the cooling channel 302b the hottest water circulating through the cooling water system to the cooling fluid outlet 212, the second coolest fluid of the incoming water stream would be in the cooling channel 304a and the third hottest outlet fluid would be flowing in the outlet cooling channel 304b. Similarly the third coolest inlet cooling fluid and the second hottest outlet cooling fluid would be flowing, respectively in inlet cooling channel 306a and outlet cooling channel 306b, and the fourth coolest inlet cooling water would be flowing in the inlet cooling channel 308a, and the fourth hottest cooling fluid would be flowing in the outlet cooling channel 308b. In this manner approximately on average each section 302, 304, 306 and 308 would have about the same capacity to transfer heat away from its adjoining transformer 56 section 56a, 56b, 56c and 56d. In this arrangement also, e.g., the coolest water entering through cooling fluid input, e.g., from a coolant fluid supply conduit 320, in the cold plate section 302 may serve to also provide some heat removal from the proximate section 308, which, e.g., may be the coolant plate 300 section over the hottest portion 56d of the step-up transformer 56.

It will be understood that the cooling fluid may be a liquid or a gas, though a liquid is preferred and water is used according to aspects of an embodiment of the present invention. In addition, it will also be understood that the cooling channels may be formed to make a plurality of loops around and back through the respective number of sections of the cold plate 300, either from the same single coolant fluid inlet 310 to the same coolant fluid outlet 312 or from a plurality of such coolant inlets and outlets, on pair for each loop of inlet and outlet channels, or a combination thereof. It will also be understood that the coolant channels, e.g., cooling channel 302a, cooling channel 302b. cooling channel 304a, cooling channel 304b, cooling channel 306a, cooling channel 306b, cooling channel 308a, and cooling channel 308b could be formed in a variety of ways, e.g., by forming a channel in at least one half of a cold plate 300, illustrated by way of example in FIG. 6, and joining it with another half of the cold plate 300 (not shown), which may or may not have matching channels, e.g., by vacuum brazing, to form a very strong single piece cold plate with internally formed channels. Alternatively, by way of example, the channels may simply be formed as, e.g., grooves 332 in the surface of the cold plate 300, e.g., with the cooling fluid flowing through the channels in a thermally conductive tubing, e.g., a copper tubing, e.g., pressed into the grooves 332, e.g., as illustrated in FIG. 7.

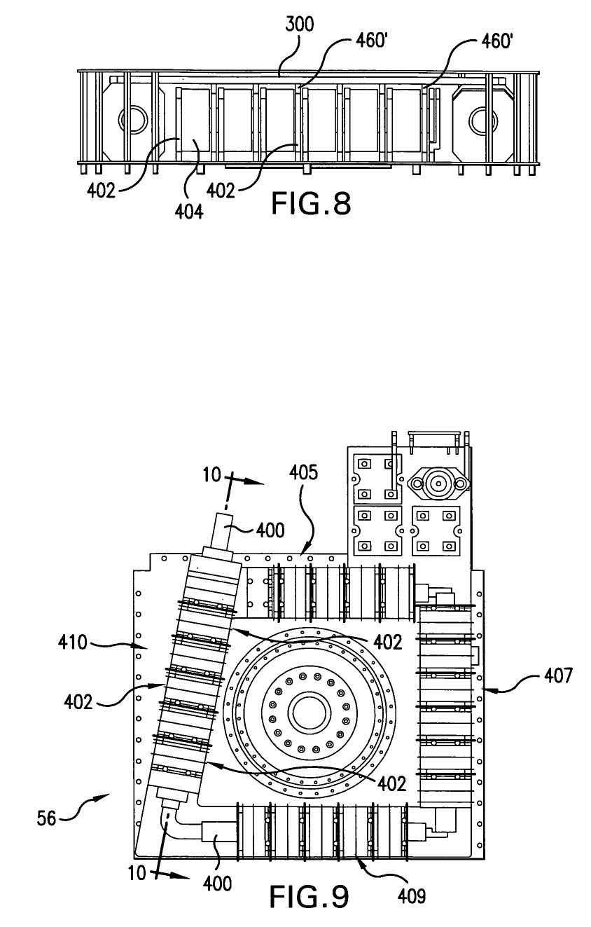

It will be understood that the cold plate 300 may be attached to the transformer 56, e.g., by extending the length of at least one side 460′ of the pucks 402 to meet the cold plate and attaching the cold plate 300 to such extended sides of the respective puck 402, e.g., by a thermally conductive adhesive, such as Silver Conductive Grease made by ITW Chemtronics, U.S.A., such as is shown in FIGS. 8, 10 and 11 Alternatively, e.g., such adhesive could be used to connect the cold plate 300 also to the puck insulators 460, such as are shown in FIG. 11.

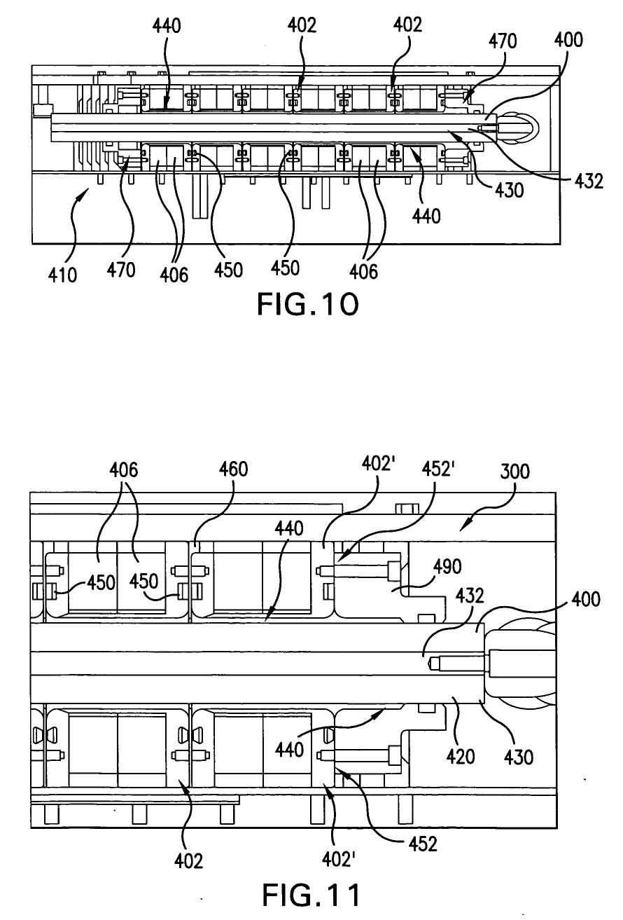

According to aspects of an embodiment of the present invention, applicants have found that during high voltage operation of the SSPPM transformer 56, corona or partial discharge can develop in the transformer 56 assembly (particularly in the region between the transformer secondary winding 400 and the individual pucks 402). The pucks 402 may each contain a single winding 404 (as shown for example in FIG. 7) or a pair of windings 406 (as shown, e.g., in FIGS. 10 and 11). Such corona discharges can be exaggerated in the pucks 402 at the high voltage end 410 of the secondary since the voltages are higher there between the secondary 400 and the respective primary, formed by the respective pucks 402.

Previously applicants' assignee's lasers systems have employed extruded coaxial cable 430, shown, e.g., in FIG. 11, so that most of the electrical field is seen in the polyethylene insulation 420 associated with the coaxial cable piece 430. Because the polyethylene is extruded over the cable center conductor 432, no air gap is allowed to exist at that location where partial breakdown or corona might develop (the polyethylene 420 also has a higher breakdown strength than air). An air gap 440 does exist at the outer diameter of the cable piece 430 (the outer diameter of the polyethylene 420) between that and the inner diameter of the respective transformer pucks 402 and respective end flanges 470. As the operating voltages increase, the fields must either be reduced in this location (by making the parts bigger) or else the insulation must be improved so that corona or breakdowns do not occur. Since neither of these solutions is particularly attractive in the applications noted herein, applicants, according to aspects of an embodiment of the present invention propose to enclose the entire transformer secondary section 400 (at least in the last transformer leg where the voltages are the highest) and then to also provide that region with pressurized insulation gas or with a liquid insulation filling to allow higher breakdown fields in the region.

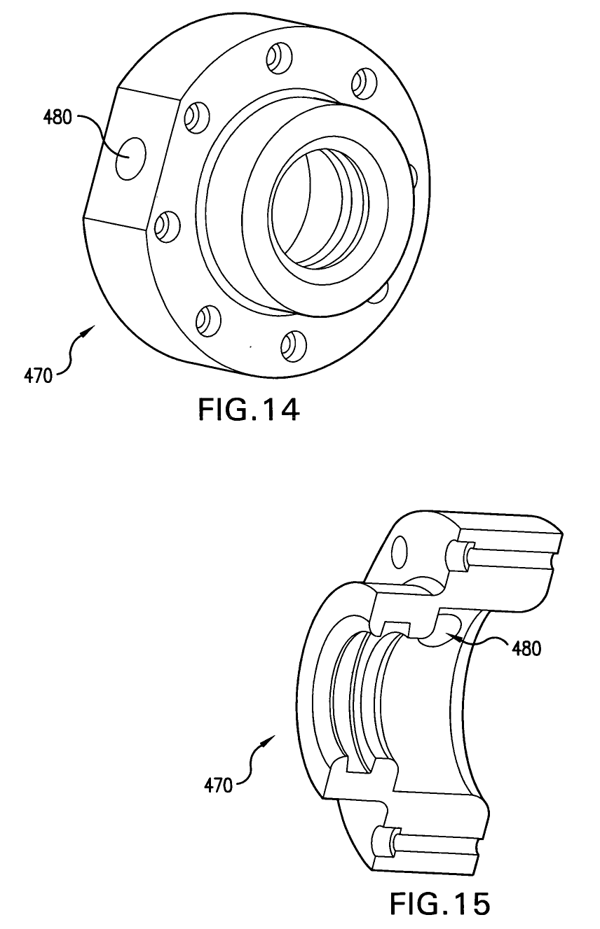

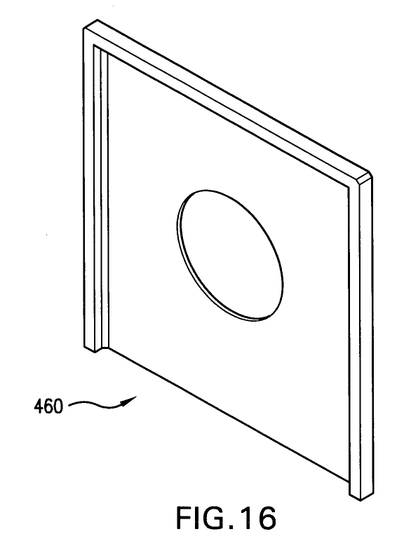

A solution, as illustrated, e.g., in FIGS. 10-16, according to aspects of an embodiment of the present invention, can, e.g., allow either pressurized gas or liquid insulation. O-rings 450 may be added between each transformer puck 402 face 452 and an insulator 460 (shown in more detail in FIG. 16 between each puck 402. In addition, flanges 470 may be added to mate against the end puck 402′ faces 452′ on the ends of at least the last high voltage leg 410 in the transformer 56. If necessary, each transformer 56 leg including the transformer legs 405, 407 and 409, as shown, e.g., in FIG. 12 (or as many as required based on the state of the voltage in each) could also be sealed and insulated in a similar manner to ensure a corona discharge did not develop in any location of the transformer secondary 400 passing through the respective leg.

As can be seen from FIGS. 10-12, the insulating spacers between pucks 402 and the space sealed by respective o-rings 450 inserted in o-ring grooves 456 formed in the puck faces 452. Similarly, the end flanges 470, shown in more detail in, e.g., FIGS. 14 and 15 may have cable o-ring seal grooves 460 into which cable o-ring seals (not shown) may be inserted to seal the ends of the respective secondary winding section 405, 407, 409 and 410. At least one of the end flanges 470 may have an opening 480 which may form the inlet for the insulating gas, e.g., N₂ or fluid, e.g., oil, or one opening 480 on one end may an inlet for the insulating gas/liquid and the other may be the outlet port.

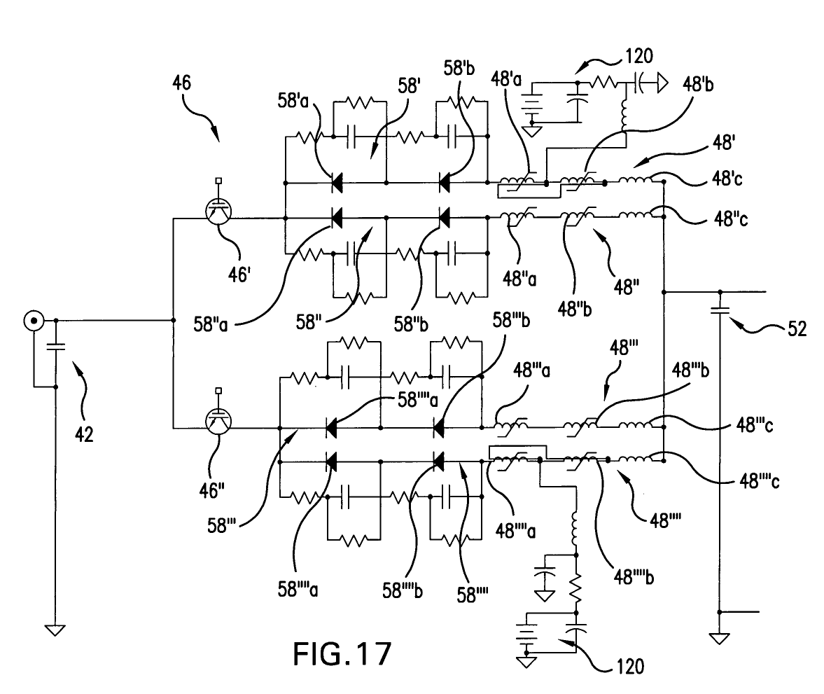

Turning now to FIG. 17 there is shown schematically a more detailed view of a portion of the circuitry shown in FIG. 1, i.e., a prior art saturable assist circuit for biasing the partly saturable inductor L₀ 48, e.g., away from saturation between openings of the solid state switch 46 to transfer the energy from capacitor C₀ 42 into the pulse compression circuitry, including, e.g., first onto a first stage capacitor C₁ 52 and the transformer 56. As noted above, the solid state switch may be a plurality of solid state switches, e.g., two solid state switches 42′ and 42″ in parallel, connected to charging capacitor C₀₋₄₂. The saturable inductor L₀ 48 and diode 58 may be a pair of saturable inductors 48′ and 48″ in series with the solid state switch 42′ and 48′″ and 48″″ in series with the solid state switch 42″. The diode 58 may be a pair of diodes 58′ and 58″ in series with the solid state switch 46′ and a pair of diodes 58′″ and 58″″ in series with the solid state switch 46″. Each of the charging inductors L₀ 48′, 48″, 48′″ and 48″″ may in turn be made up of a first saturable inductor 48′a, 48″a, 48′″a and 48″″a and a second saturable inductor 48′b, 48″b, 48′″b and 48″″b, and an inductor 48′c, 48″c, 48′″c and 48″″c.

Each of the diodes 58′, 58″, 58′″ and 58″″ may comprise a pair of series connected diodes 58′a and b, 58″a and b, 58′″a and b and 58″″a and b, each with a respective resonance bypass circuit. Each of the charging inductors L₀ 48′, 48″, 48′″ and 48″″ has in this prior art circuit 120 that may be used to bias respective ones of the inductor pairs 48′, 48″ and 48′″, 48″″, e.g., by being magnetically connected, respective to the cores of saturable inductors 48′ a and b on the one hand and 48″″ a and b on the other.

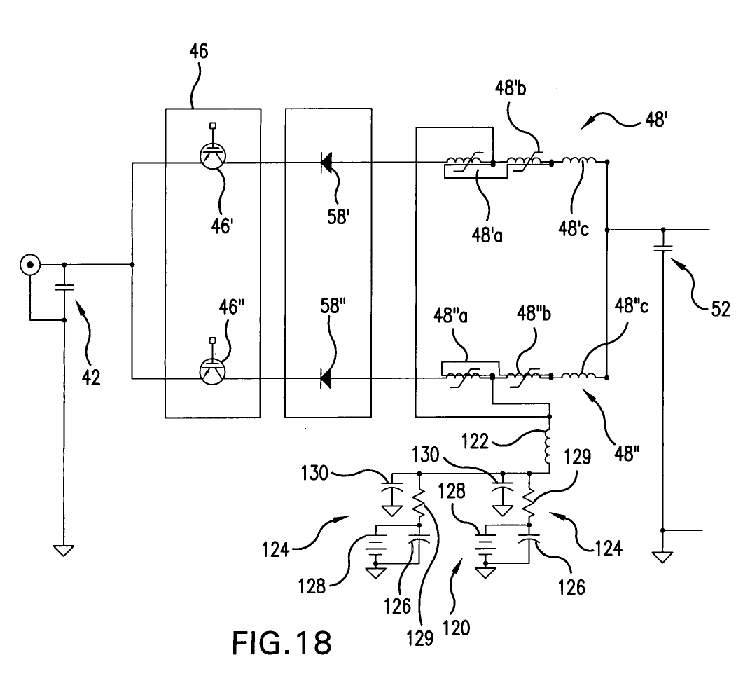

Turning now to FIG. 18, there is shown an improved circuit to that of FIG. 17, wherein, e.g., the diode arrays 58′ and 58″ have been replaced with a single diode 58′ and the diode arrays 58′″ and 58″″ have bee replaced with a single diode 58′, neither of which has a respective resonance circuit shown in FIG. 17. Similarly the pairs of charging inductors 48′ and 48″ and 48′″ and 48″″ have been replaced by a single charging inductor 48′ in series with solid state switch 46′ and 48″ in series with solid state switch 46″.

A single biasing circuit 120′ which may comprise a bias inductor 122, in series with a parallel arrangement of two identical RC circuits 124 which may comprise a 24000 μF capacitor 126 across a 5V dc biasing voltage power supply 128 and series with a 0.1 ohm resistor 129, both in parallel with a 12000 μF capacitor 130.

The bias inductor 122 may also be connected in parallel with the saturable portions 48′ a and b and 48″ a and b of the respective charging inductors 48′ and 48″. such an arrangement, in addition to being less costly can provide for a smoother and more echonomical transition of the energy from Charging Capacitor C₀ 42 to first stage capacitor C₁ 52 when the solid state switches 46′ and 46″ are closed.

While the particular aspects of embodiment(s) of the 6K PULSE REPETITION RATE AND ABOVE GAS DISCHARGE LASER SYSTEM SOLID STATE PULSE POWER SYSTEM IMPROVEMENTS described and illustrated in this patent application in the detail required to satisfy 35 U.S.C. §112 is fully capable of attaining any above-described purposes for, problems to be solved by or any other reasons for or objects of the aspects of an embodiment(s) above described, it is to be understood by those skilled in the art that it is the presently described aspects of the described embodiment(s) of the present invention are merely exemplary, illustrative and representative of the subject matter which is broadly contemplated by the present invention. The scope of the presently described and claimed aspects of embodiments fully encompasses other embodiments which may now be or may become obvious to those skilled in the art based on the teachings of the Specification. The scope of the present 6K PULSE REPETITION RATE AND ABOVE GAS DISCHARGE LASER SYSTEM SOLID STATE PULSE POWER SYSTEM IMPROVEMENTS is solely and completely limited by only the appended claims and nothing beyond the recitations of the appended claims. Reference to an element in such claims in the singular is not intended to mean nor shall it mean in interpreting such claim element “one and only one” unless explicitly so stated, but rather “one or more”. All structural and functional equivalents to any of the elements of the above-described aspects of an embodiment(s) that are known or later come to be known to those of ordinary skill in the art are expressly incorporated herein by reference and are intended to be encompassed by the present claims. Any term used in the specification and/or in the claims and expressly given a meaning in the Specification and/or claims in the present application shall have that meaning, regardless of any dictionary or other commonly used meaning for such a term. It is not intended or necessary for a device or method discussed in the Specification as any aspect of an embodiment to address each and every problem sought to be solved by the aspects of embodiments disclosed in this application, for it to be encompassed by the present claims. No element, component, or method step in the present disclosure is intended to be dedicated to the public regardless of whether the element, component, or method step is explicitly recited in the claims. No claim element in the appended claims is to be construed under the provisions of 35 U.S.C. § 112, sixth paragraph, unless the element is expressly recited using the phrase “means for” or, in the case of a method claim, the element is recited as a “step” instead of an “act”.

It will be understood by those skilled in the art that the aspects of embodiments of the present invention disclosed above are intended to be preferred embodiments only and not to limit the disclosure of the present invention(s) in any way and particularly not to a specific preferred embodiment alone. Many changes and modification can be made to the disclosed aspects of embodiments of the disclosed invention(s) that will be understood and appreciated by those skilled in the art. The appended claims are intended in scope and meaning to cover not only the disclosed aspects of embodiments of the present invention(s) but also such equivalents and other modifications and changes that would be apparent to those skilled in the art. In additions to changes and modifications to the disclosed and claimed aspects of embodiments of the present invention(s) noted above others could be implemented.

I/We claim:

1. A very high repetition gas discharge laser system magnetic switch pulsed power system comprising:
a solid state switch,
a charging power supply electrically connected to one side of the solid state switch;
a charging inductor electrically connected to the other side of the solid state switch;
a deque circuit electrically in parallel with the solid state switch comprising a deque switch;
a peaking capacitor electrically connected to the charging inductor,
a peaking capacitor charging control system operative to charge the peaking capacitor by opening the deque switch and leaving the solid state switch open and then shutting the solid state switch.

2. The apparatus of claim 1 further comprising:
the solid state switch comprises a plurality of solid state switches electrically in parallel.

3. The apparatus of claim 1 further comprising:
the peaking capacitor charging control system is operative to charge the peaking capacitor by leaving the deque switch open until substantially all of the electrical energy stored in the charging inductor has been removed before shutting the solid state switch.

4. The apparatus of claim 2 further comprising:
the peaking capacitor charging control system is operative to charge the peaking capacitor by leaving the deque switch open until substantially all of the electrical energy stored in the charging inductor has been removed before shutting the solid state switch.

5. A very high repetition gas discharge laser system magnetic switch pulsed power system comprising:
a solid state switch,
a charging power supply electrically connected to one side of the solid state switch;
a charging inductor electrically connected to the other side of the solid state switch;
a peaking capacitor electrically connected to the charging inductor,
a delay circuit operative to charge the peaking capacitor with electrical energy stored in the charging inductor prior to shutting the solid state switch.

6. A very high repetition gas discharge laser system magnetic switch pulsed power system comprising:
a step-up transformer comprising a plurality of winding pucks each comprising a turn primary winding around a secondary winding;
each of the plurality of pucks contained in at least two separate sections of primary winding pucks laid out on a step-up transfer mounting board at angles to each other generally forming an L or a U or an O shaped compilation having a first and a second end;
a cooling plate having a plurality of sections each respectively in thermal contact with a respective one of the at least two separate sections of the primary winding pucks;
the cooling plate comprising a plurality of cooling channels arranged in at least one grouping of a pair of channels extending in a flow direction from the first end to the second end and returning to the first end, from a cooling fluid inlet at the first end to a cooling fluid outlet at the first end.

7. The apparatus of claim 6 further comprising:
the cooling channel comprising a channel internal to the cooling plate.

8. The apparatus of claim 7 further comprising:
the cooling channel is formed in at least a first half of the cooling plate and the first half of the cooling plate is joined to a second half of the cooling plate.

9. The apparatus of claim 6 further comprising:
the cooling channel comprises a cooling fluid duct contained in a cooling fluid duct passage groove formed in a surface of the cooling plate.

10. The apparatus of claim 7 further comprising:
the cooling fluid duct comprising thermally conductive tubing.

11. A very high repetition gas discharge laser system magnetic switch pulsed power system comprising:
a step-up transformer comprising a plurality of winding pucks each comprising a single turn primary winding around a secondary winding;
a void space between an internal surface of each respective primary winding puck and an insulation sleeve on the secondary winding;
and insulation fluid in the void space.

12. The apparatus of claim 11 further comprising:
the insulation fluid comprising a dielectric gas.

13. The apparatus of claim 11 further comprising:
the insulation fluid comprising a noble gas.

14. The apparatus of claim 11 further comprising:
the insulation fluid comprising N₂.

15. The apparatus of claim 11 further comprising:
the insulation fluid comprising a dielectric liquid.

16. The apparatus of claims 11 further comprising:
the insulation fluid comprising a dielectric oil.

17. A very high repetition gas discharge laser system magnetic switch pulsed power system solid state switch anti-jitter and anti-drift circuit comprising:
an optoisolator circuit spanning the boundary between the high voltage side of the circuit and the low voltage side of the circuit, comprising:
an opto-transmitter on the low voltage side of the circuit and an opto-receiver on the high voltage side of the circuit.

18. The apparatus of claim 17 further comprising:
a comparator in series with the opto-receiver and the solid state switch between the opto-receiver and the solid state switch.

19. The apparatus of claim 17 further comprising:
the opto-transmitter is connected to a trigger input signal.

20. The apparatus of claim 17 further comprising:
the comparator is connected to an MOSFET driver circuit.
